(19) United States
(12) Patent Application Publication
(10) Pub. No.: US 2024/0248199 A1
(43) Pub. Date: Jul. 25, 2024

(54) RADAR FOR DETECTION OF CONCEALED OBJECTS

(71) Applicant: Pavlo A. Molchanov, Las Cruces, NM (US)

(72) Inventor: Pavlo A. Molchanov, Las Cruces, NM (US)

(21) Appl. No.: 18/100,882

(22) Filed: Jan. 24, 2023

(51) Int. Cl. G01S 13/88; G01S 7/02; G01S 7/03; G01S 7/36; G01S 7/41; G01S 13/44

(52) U.S. Cl. CPC G01S 13/887; G01S 7/024; G01S 7/032; G01S 7/36; G01S 7/411; G01S 13/4409; G01S 13/888

(57) ABSTRACT

Radar for automatic detection and identification concealed objects based on integration of holographic non-scanning antenna array with monopulse high directional accuracy method of fast direction finding and direct digitizing of signals on each directional antenna relatively to processor sampling signals, real time processing of received three-dimensional interferograms in time and frequency domains. Antennas coupled with signal conditioning circuits and SDR (Software Defined Radio) arranged as integrated transceiver antenna modules connected to multi-beam signal processor by digital interface arranged as universal serial bus or microwave and/or fiber optic waveguides or wirelessly. It allows distribution of integrated transceiver antennas modules around vehicle perimeter or between drone's swarm and provides additional system protection against jamming, spoofing or EM pulse. Transformation and processing of different polarizations signals in time domain, frequency domain and multi-axis space domain decreasing false errors probability and enhance identification by spectrum signature.

### FIELD OF CLASSIFICATION SEARCH

CPC: G01S13/888 (2013.01); G01S13/88 (2013.01); G01S13/00 (2013.01); G01S13/003 (2013.01); G01S13/584 (2013.01); G01S7/41 (2013.01); G01S7/412 (2013.01); G01S7/36 (2013.01); G01S7/354 (2013.01);
H04B 5/00 (2013.01); H04B 7/00 (2013.01);
H04B 7/0495 (2013.01); H01Q 21/06 (2013.01); G01N23/043 (2013.01);
A61B 5/00 (2013.01); A61B 6/00 (2013.01).

### REFERENCES CITED

### US Patent Documents

US 2016/0223666 A1 04/08/2016 Jacob Kim
U.S. Pat. No. 9,810,774 B2 07/11/2017 Peter S. Wittenberg
U.S. Pat. No. 7,492,303 B1 17/02/2009 Arthur C. Levitan
US 20140035783 A1 02/06/2014 Pavlo A. Molchanov

### Other Publications

1. Stephen A. Harman “A comparison of staring radars with scanning radars for UAV detection: introduction of the Alarm™ staring radar”, 2015, European Radar Conference (EURAD), EUMA, Sep. 2015, 185-188, XP032824534.
2. Stephen A. Harman, (Aveillant Ltd., Cambridge, U.K.),” Holographic Radar Development”, 2021-02-07 (microwavejournal.com).
3. Stephen E. Lipsky, “Microwave Passive Direction Finder”, SciTech Publishing Inc. Raleigh, NC 27613, 2004. High frequency electronics, pp. 22-27. May 2022.
4. Pavlo A. Molchanov, Ashok Gorwara, “Fly Eye Radar Concept”. IRS2017. International Radar Symposium, Prague, July 2017.

### PRIOR ART

Border protection, customs and inspection against threats requiring development of mobile automatic detection technologies and devices rapidly as criminals and their techniques become more sophisticated. Digital transformation of industries and the growing automation of processes, there is now a need for simple, fast and accurate detection tools. Automatic object recognition technology can increase efficiency by offering faster analysis with a higher probability of detection. Threats vary according to the location and type. It may be narcotics or cigarettes in containers, weapons coming in. Threats vary again in landlocked countries, where cargo flow of goods may raise the risk of traffic and contraband coming through.

A method for detecting a concealed material in a target comprising a body and the concealed material, the method comprising: emitting radio frequency (RF) energy toward a direction of the target, capturing a signal corresponding to a scattered RF energy reflected from the target, measuring a first mean signal level in a first frequency band of the signal, measuring a second mean signal level in a second frequency band of the signal, and detecting the concealed material when the difference between the first mean signal level and the second mean signal level is above a threshold are presented in Prior ART FIG. 1, US 2016/0223666 A1. The emitter may emit RF energy of a horizontal or vertical polarity. The captured scattered RF energy reflected from the target may have a horizontal or vertical polarization. The first frequency band may be a frequency range in which the concealed material has a resonant RF scattering response, but in which the body lacks a resonant RF scattering response.

A multi-beam frequency-modulated continuous wave (FMCW) radar system designed for short range (<20 km) operation in a high-density threat environment against highly maneuverable threats. The multi-beam FMCW system is capable of providing continuous updates, both search and track, for an entire hemisphere against short-range targets. The multi-beam aspect is used to cover the entire field of regard, whereas the FMCW aspect is used to achieve resolution at a significantly reduced computational effort (PRIOR ART FIG. 2, U.S. Pat. No. 9,810,774 B2) More specifically, in a multi-beam FMCW radar system suitable for use as a short-range point defense system, the transmit beam should be able to cover the entire field of regard Power levels on transmit should not be excessive. On the receive side, multiple beams are used to cover the field of regard. Ideally, the receive side will be covered with many overlapping beams. The intent is to cover the entire field of regard with high-gain beams. When the signals return to the receiver from the target, they need to be formed into multiple receive beams, and this needs to be done with a computationally realistic processing load. There are numerous engineering tradeoffs involved in this, including angular accuracy and range resolution. The system should be able to operate with a something close to a typical exciter with some modifications that may be desirable.

Methods and apparatus for early detection and identification of a threat such as individuals carrying hidden explosive materials, land mines on roads, etc. are disclosed. One method comprises illuminating a target with radiation at a first polarization, collecting first radiation reflected from the target which has the same polarization as the first polarization, illuminating a target with radiation at a second polarization, and collecting second radiation reflected from the target which has the same polarization as the second polarization. A threat determination is then made based on the difference between the energy values of the first and second collected radiations. In other embodiments, the difference between energy values is used in conjunction with an evaluation of the returned energy in comparison with returned energy from other targets in order to additionally assess whether the primary target is a threat. In presented in Prior ART FIG. 3 U.S. Pat. No. 7,492,303 B1 apparatus can be mounted on mobile devices or positioned at fixed locations. The mobile mounted embodiments can be used by trucks and/or other vehicles to identify possible roadside threats or threats which may exist in the vehicle's direction of travel. Such threats include, e.g., above ground mines, improvised explosive devices and/or other types of weapons. In cases where hidden weapons on individuals is the primary concern, the display may limit the visual display of information to areas, e.g., cells of a scanned region, where a human presence is detected, e.g., through the use of thermal or other information Such an embodiment reduces clutter on the display and helps a user focus on potential threats.

### BACKGROUND OF THE INVENTION

Present invention related to radar or analogous systems specially adapted for specific applications for detection of concealed objects, e.g. contraband or weapons through wall detection. More particular to identification of targets based on measurements of radar reflectivity based on a comparison between measured spectrum components and known or stored values, analysis of echo signal for objects characterization by spectrum signature.

Multi-beam antenna array can cover of entire sky, but phase array with steering beam cannot provide non-interrupting communication with all signal sources simultaneously and scanning/switching beams are limiting communication line's budget. Phase of sinusoidal signal directly connected with frequency and phase correction needed to extend of frequency band. Trade between frequency band, gain and switching active time leads to interrupting line's budget and loos signal and/or data rate. Traditional phase arrays with scanning the volume of coverage giving limited dwell time on any given signal source. This limits the information that can be obtained for each source as well as limiting link budget [1,2].

Proposed nature inspired multi-beam antenna array architecture with multiple staring directional antennas will cover entire sky and allows real time recording of digital hologram. Integration of holographic non-scanning antenna system [1.2] with monopulse high directional accuracy method of signals processing directly on multi-beam multi-axis overlap antennas [3] and direct on antennas digitizing will provide fast threat detection, tracking and recognition.

This type of commercial multibeam wireless phased array antenna systems are requiring beamforming and beam shaping networks, which increasing mass and cost of system.

Phase array scattering approx. 80% of transmitting power to air because control of transmitting signals phase only without switching direction in separate antenna element does not mean control of direction of entire phase array, because every antenna element transmitting energy omnidirectionally. Antenna elements forming phase array must have as possible wide angle of view, means be omnidirectional. Efficiency of four beams antenna system too small because gain of each antenna formed beam four times smaller than possible corresponding to antenna array aperture. Gain of each beam equal to maximum possible gain divided to number of beams for omni-directional antenna elements.

Such multi-beam antenna array can provide up to 96 dual-polarized beams/sectors in 360° azimuth but only approx. 120 degrees by elevation because plane panel surface.

True antenna system capacity multiplied by number of beams, but limited by frequency bands because electronic scanning system, or phase array is frequency dependent. Phase directly connected to frequency and bandwidth can be extended by trade with gain, direction limit and switching active time only.

Fixed beams with fixed direction cannot provide adaptation of signal to noise ratio without reference channel.

Array of directional antennas with overlap antenna patterns and multi-channel signal's processing provides higher direction-finding accuracy, direction adjustment possibility and faster signals processing Stephen E. Lipsky [3].

Fly Eye antenna system described in [4] by Pavlo A. Molchanov can provide 360 degree coverage by azimuth and elevation, continuous higher gain and capacity in each channel, one-step direction adjustment and adaptation to transferring media and multi-band work limited by directional antenna bandwidth only.

### SUMMARY OF THE INVENTION

An objective of the present invention is development of radar for automatic detection and identification concealed objects based on integration of holographic non-scanning antenna array with monopulse high directional accuracy method of fast direction finding and direct digitizing of signals on each directional antenna relatively to processor sampling signals and real time processing of three-dimensional interferograms in time and frequency domains. Radar comprising multiple directional antennas coupled with signal conditioning circuits and SDR (Software Defined Radio) arranged as integrated transceiver antenna modules connected to multi-beam signal processor by digital interface arranged as universal serial bus or microwave and/or fiber optic waveguides or wirelessly. It allows distribution of integrated transceiver antennas modules around vehicle perimeter or between drone's swarm and provides additional system protection against jamming, spoofing or EM pulse. Transformation and processing of received different polarization signals in time domain, frequency domain and multi-axis space domain decreasing false errors probability and enhance identification by spectrum signature.

Proposed multi-channel continuous wave radar for detection of concealed objects configured to transmit and receive horizontally, vertically or circular polarized waveforms. Radar comprising as minimum one transceiver antenna module with multiple directional antennas wherein antenna patterns overlap in one or more directions for creating monopulse subarrays continuously covering of entire area of observation or subdivided sector. Each directional antenna formed by subarray of antenna elements arranged in module volume, on module surface or combined. Said transceiver antenna module comprising as minimum one transmitting chain including phase lock loop signal generator and controllable power amplifier coupled with directional antenna and connected to software defined radio. Also said transceiver antenna module comprising multiple conditioning receiving chains including voltage or current limiters, anti-aliasing circuits wherein each conditioning receiving chain coupled with directional antenna and connected to software defined radio. All transceiver antenna modules connected to multi-channel signal processor by digital interface arranged as universal serial bus (USB) or microwave and/or fiber optic waveguides. Multi-channel signal processor comprising memory, monopulse processor, objects identification means, and synchronization means. Memory arranged for storing executable instructions and for separate processing of amplitudes, phases, frequency components shift of signals in transmitting and receiving chains. Monopulse processor arranged for simultaneous multi-axis processing of all signals in receiving chains for calculating objects azimuth and range as ratio of amplitudes and/or phase shift of signals, one-iteration adapting to decrease transferring media influence to receiving chain parameters by phase shift in subarray of neighboring directional antennas with overlap antenna patterns. Objects identification means arranged to transform three-dimensional interferogram from time domain to frequency domain, creating spectrum signatures and identification of objects. Synchronization means arranged for synchronizing transmitting, receiving chains and software defined radios with multi-channel signal processor time. Plurality of multi-beam antenna array modules can be distributed by some order on carrier/satellite, vehicle or distributed between swarm or constellation of carriers/satellites to cover entire sky or area of observation.

In some embodiment said multi-channel continuous wave radar transceiver antenna module can be arranged in concave, convex, cylindric full/hemi sphere shape consisting of plurality of antenna elements which forming directional antennas.

Transmitting and receiving chains and multi-channel signal processor can be arranged for simultaneous transmitting, receiving, and processing signals on a few different frequencies (multi-frequency signals) and comprising corresponding arranged directional antennas, anti-aliasing circuits and filtering means in each transmitter and receiving chain.

In some embodiments of multi-channel continuous wave radar transmitting and receiving circuits and signal processor can be arranged for simultaneous transmitting, receiving, and processing different modes and different waveforms signals, such as communication, navigation, control (multi-mode, multi-function signals) and comprising corresponding arranged directional antennas, anti-aliasing circuits and filtering means in each transmitter and receiving chain.

Multi-channel continuous wave radar comprising receiving circuits and multi-channel signal processor can be arranged for simultaneous processing received signals for detection direction of arriving of jam and/or spoof signals and comprising corresponding arranged analog and digital filtering and/or switching protection means in each receiving chain and in each channel of signal processor.

Second embodiment of multi-channel continuous wave radar for detection of concealed objects arranged as multi-static radar with one or a few transmitting modules distributed and multiple receiving only antenna array modules with automatic objects recognition and wirelessly connected with operator. Multi-static radar comprising as minimum one transmitter module comprising transmitting chain including phase lock loop signal generator, and controllable power amplifier coupled to as minimum one antenna continuously covering of entire area of observation or subdivided sector and connected by digital interface to wireless transceiver module and INS/GPS module. Multiple multi-beam receiver antenna modules comprising multiple directional antennas wherein antenna patterns overlap in one or more directions for creating monopulse subarrays continuously covering of entire area of observation or subdivided sector and comprising multiple conditioning receiving chains including voltage or current limiters, anti-aliasing circuits wherein each conditioning receiving chain coupled with separate directional antenna and software defined radio. Each directional antenna formed by subarray of antenna elements arranged in module volume, on module surface or combined. All multi-beam receiver modules connected to multi-channel signal processor, wireless transceiver module and INS/GPS module by digital interface arranged as universal serial bus (USB) or microwave and/or fiber optic waveguides. Multi-channel signal processor comprising memory, monopulse processor, objects identification means and synchronization means.

### BRIEF DESCRIPTION OF DRAWINGS

PRIOR ART FIG. 1 illustrates of the radar for detection of a concealed object on a body.

PRIOR ART FIG. 2 shows known short range point defense radar.

PRIOR ART FIG. 3 shows method and apparatus for detection threats using radar.

FIG. 1 illustrates multi-channel continuous wave radar for detection of underground concealed objects.

FIG. 2 illustrates multi-channel continuous wave radar for detection of behind wall concealed objects.

In FIG. 3 shown diagram for detection and recognition of sniper riffle from airborne drone by spectrum signature.

FIG. 4 shows frequency components after transform from tree-dimensional interferogram to frequency domain.

FIG. 5 shows result of spectrum changing and background frequency components when receiving antenna moving relative to underground concealed object.

Diagram in FIG. 6 shows separation of media disturbance from object image.

FIG. 7 shows multi-beam transceiver antenna module.

FIG. 8A shows multi-beam receiver antenna module with wireless connection to operator.

FIG. 8B show transmitter antenna module with wireless connection to operator.

In FIG. 9 shown block-diagram of passive receiver antenna module with ultrawide band directional antenna.

FIG. 10 shows multi-band directional antenna array with monopulse overlap antenna patterns.

FIG. 11 shows sample of embodiment for two-band directional antenna array.

Diagram in FIG. 12 shows application of airborne drone for detection of hazard materials concealed on ground surface or underground.

FIG. 13 shows sniper detection with multi-channel transceiver antenna modules and wireless connected operator.

FIG. 14 shows detection of concealed threats detection in airports.

FIG. 15 shows samples of directional antenna modules for L1, L2 GPS frequency bands.

### DETAILED DESCRIPTION OF THE INVENTION

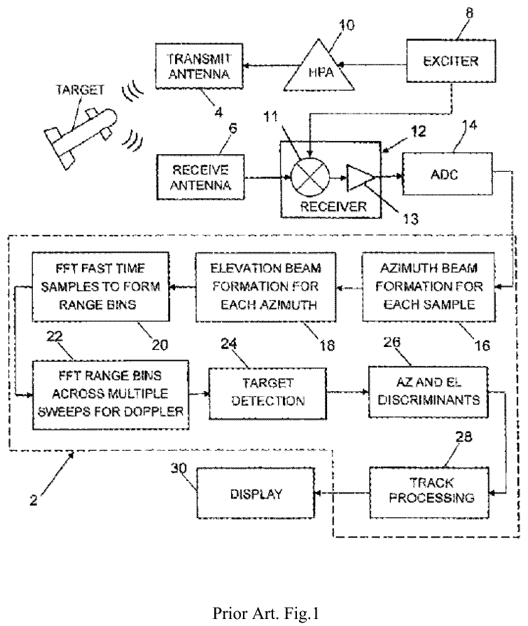

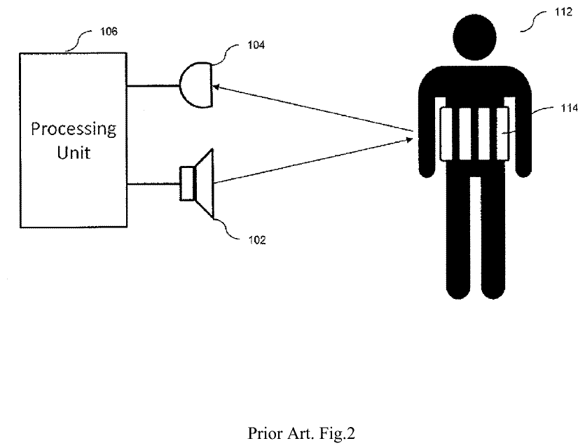

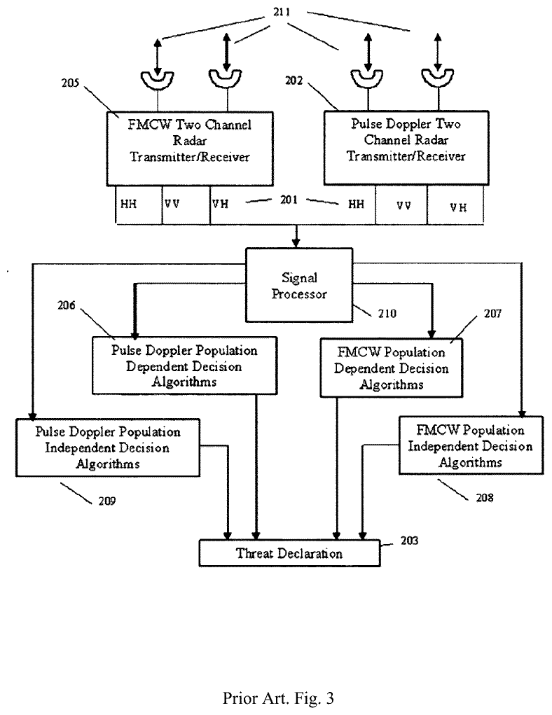

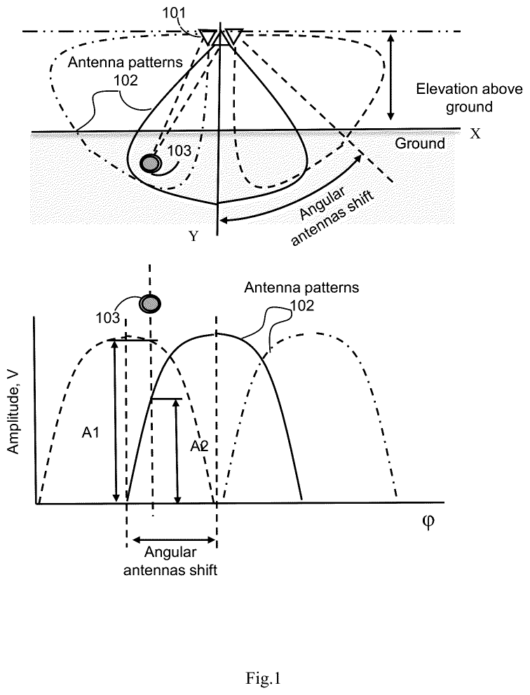

Application of antenna array for detection and recognition of underground concealed object by monopulse method is shown in FIG. 1. Antenna array comprising three angular shifted directional antennas 101 wherein antenna patterns 102 overlap in X direction for creating monopulse subarray continuously covering of subdivided sector. Overlap antenna patterns allows calculate object 103 position as ratio of amplitudes A1, A2 and/or phases of reflected signals with high, accuracy. Signals in reference antennas can help to suppress ground clutter and increase detection reliability.

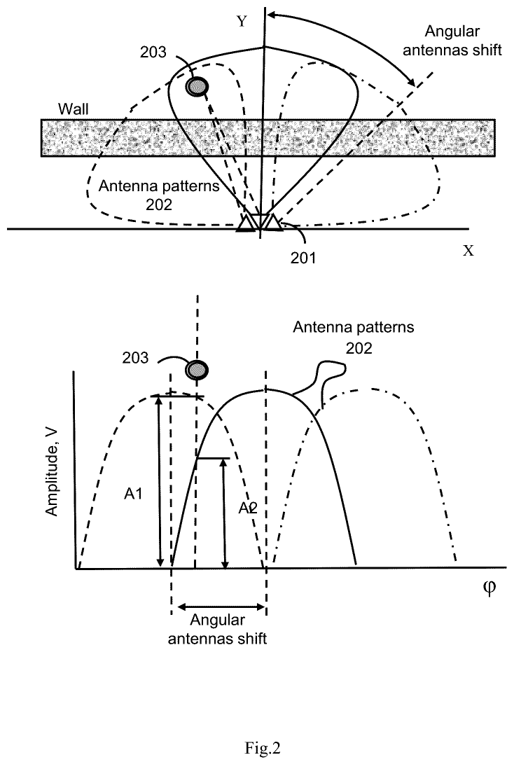

Application of antenna array for through wall detection of concealed object by proposed method is shown in FIG. 2. Antenna array comprising three angular shifted directional antennas 201 wherein antenna patterns 202 overlap in X direction for creating monopulse subarray continuously covering of wide subdivided sector. Overlap antenna patterns allows calculate object 203 position as ratio of amplitudes A1, A2 and/or phases of reflected signals with high directional accuracy. Signals in reference antennas provides better reliability and can help to suppress spectrum components corresponding to wall 204 noise.

In FIG. 3 shown diagram for detection and recognition of sniper riffle from airborne drone by spectrum signature. Transceiver Antenna Modules (TAM) with overlapping antenna patterns attached to drone 302. TAM transmitting continuous wave Radio Frequency (RF) signal 303. Part of transmitted signal 304 diffracting from sniper riffle 305, and part of signal 306 reflecting from obstacles 306. It may be buildings 307. All received signals can be presented in three-dimensional interferogram, wherein signals diffracted from sniper riffle have phase delay 308 and signals reflected from obstacles have time delay 309. Transform of three-dimensional interferogram to frequency domain, for example with Fast Fourier Transform (FFT) 310 allows to filter diffracted from sniper riffle signals in form of spectrum signature 311. Alarm signal automatically generating if spectrum signature matching to recorded in library spectrum 312.

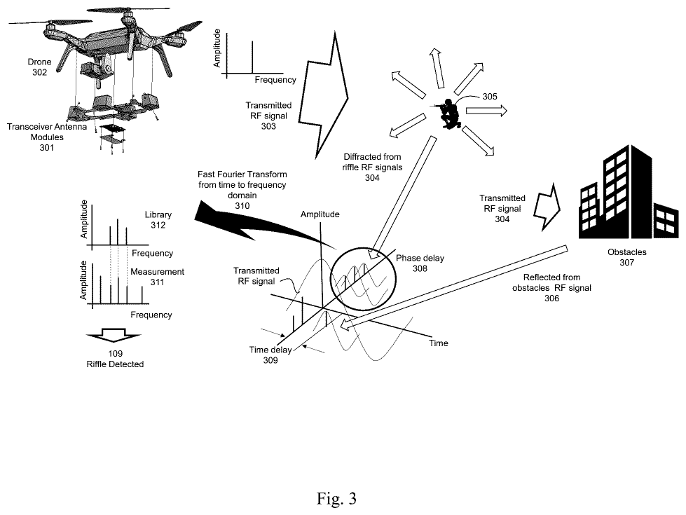

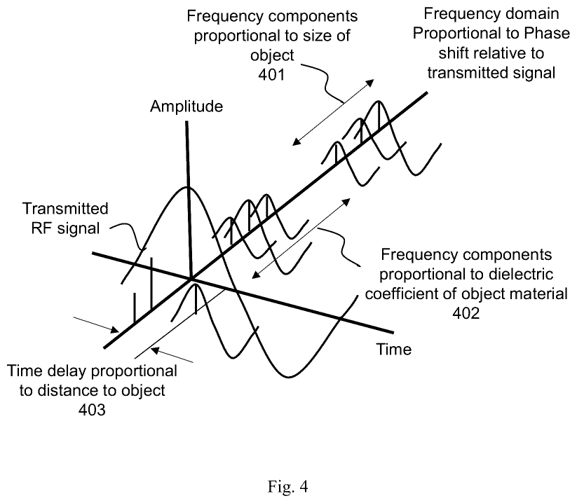

In FIG. 4 presented frequency components of received signals after transform from tree-dimensional interferogram to frequency domain. Spectrum usually consisting of three groups of frequency components. First group are frequency components are proportional to size of diffracted/reflected object 401, second group are frequencies are proportional to dielectric constant of object material 402. Third group of frequency components are proportional to distance to reflecting object or obstacles 403.

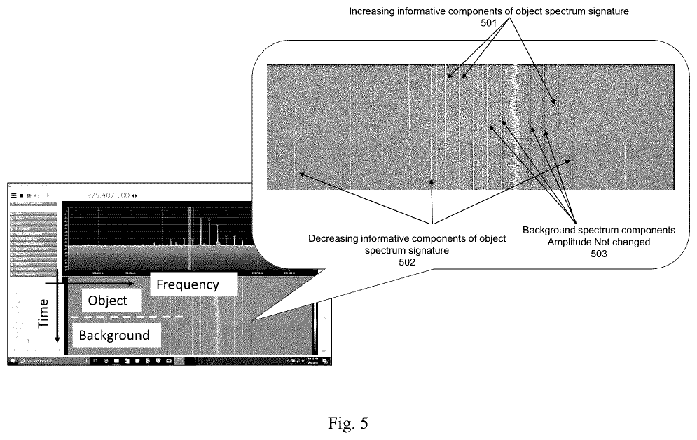

FIG. 5 shows result of spectrum changing and background frequency components when receiving antenna moving relative to underground concealed object. Some of spectrum components 501 corresponding to concealed underground object (bucket with fertilizer in this test case) are increasing, and some 502 are decreasing. But all spectrum components 501 and 502 are belong to concealed object and can be applied for object recognition. Frequency components 503 are not changing when antenna moving. These components are corresponding to ground background, which can be suppressed in proposed radar.

Diagram in FIG. 6 shows separation of media disturbance from object image. Object beam 601 receiving signals diffracted/reflected from object. Reference beam can be directed to object 602. In this case reference signal can be applied for suppressing media disturbance by cross-correlation algorithm. Reference beam can be directed to scattering media 603 too. In this case media noise can be suppress by subtraction or adaptation algorithms.

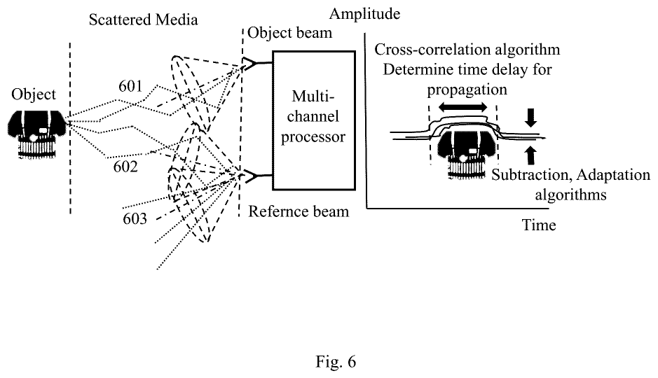

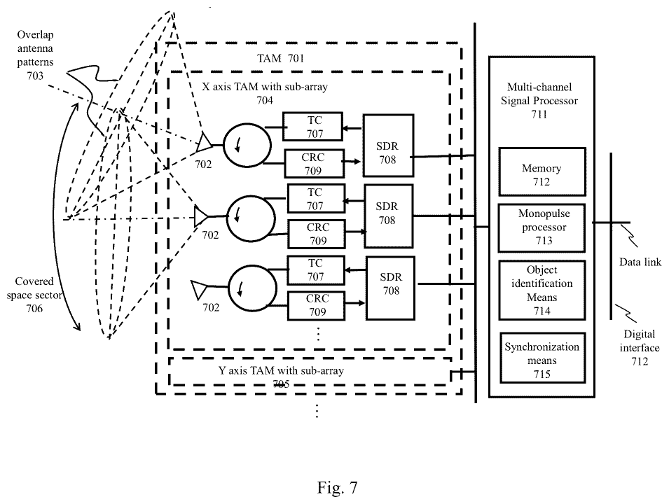

First embodiment of multi-beam transceiver antenna module is illustrated in FIG. 7. Proposed multi-channel continuous wave radar for detection of concealed objects configured to transmit and receive horizontally, vertically or circular polarized waveforms. Radar comprising as minimum one transceiver antenna module 701 with multiple directional antennas 702 wherein antenna patterns 703 overlap in one or more directions for creating monopulse subarrays continuously 704, 705 covering of entire area of observation 706 or subdivided sector. Each directional antenna formed by subarray of antenna elements arranged in module volume, on module surface or combined. Said transceiver antenna module comprising as minimum one transmitting chain 707 including phase lock loop signal generator and controllable power amplifier coupled with directional antenna 702 and connected to software defined radio 708. Also said transceiver antenna module 701 comprising multiple conditioning receiving chains 709 including voltage or current limiters, anti-aliasing circuits wherein each conditioning receiving chain coupled by circulator 710 with directional antenna 702 and connected to software defined radio 708. All transceiver antenna modules 701 connected to multi-channel signal processor 711 by digital interface 712 arranged as universal serial bus (USB) or microwave and/or fiber optic waveguides. Multi-channel signal processor 711 comprising memory 712, monopulse processor 713, objects identification means 714, and synchronization means 715. Memory 712 arranged for storing executable instructions and for separate processing of amplitudes, phases, frequency components shift of signals in transmitting and receiving chains. Monopulse processor 713 arranged for simultaneous multi-axis processing of all signals in receiving chains for calculating objects azimuth and range as ratio of amplitudes and/or phase shift of signals, one-iteration adapting to decrease transferring media influence to receiving chain parameters by phase shift in subarray of neighboring directional antennas with overlap antenna patterns. Objects identification means 714 arranged to transform three-dimensional interferogram from time domain to frequency domain, creating spectrum signatures and identification of objects. Synchronization means 715 arranged for synchronizing transmitting, receiving chains and software defined radios with multi-channel signal processor time. Plurality of multi-beam transceiver antenna modules 701 can be distributed by some order on carrier/satellite, vehicle or distributed between swarm or constellation of carriers/satellites to cover entire sky or area of observation. Distribution of integrated transceiver antenna modules 701 around vehicle perimeter or between drone's swarm and provides additional system protection against jamming, spoofing or EM pulse. Transformation and processing of received signals in time domain, frequency domain and multi-axis space domain decreasing false errors probability and enhance identification by spectrum signature.

In some embodiment said multi-channel continuous wave radar transceiver antenna modules 701 can be arranged in concave, convex, cylindric full/hemi sphere shape consisting of plurality of antenna elements which forming directional antennas.

Transmitting 707 and receiving 709 chains and multi-channel signal processor 711 can be arranged for simultaneous transmitting, receiving, and processing signals on a few different frequencies (multi-frequency signals) and comprising corresponding arranged directional antennas, anti-aliasing circuits and filtering means in each transmitter and receiving chain.

In some embodiments of multi-channel continuous wave radar transmitting 707 and receiving 709 circuits and signal processor 711 can be arranged for simultaneous transmitting, receiving, and processing different modes and different waveforms signals, such as communication, navigation, control (multi-mode, multi-function signals) and comprising corresponding arranged directional antennas, anti-aliasing circuits and filtering means in each transmitter and receiving chain.

Receiving circuits 707 and multi-channel signal processor 711 can be arranged for simultaneous processing received signals for detection direction of arriving of jam and/or spoof signals and comprising corresponding arranged analog and digital filtering and/or switching protection means in each receiving chain and in each channel of signal processor.

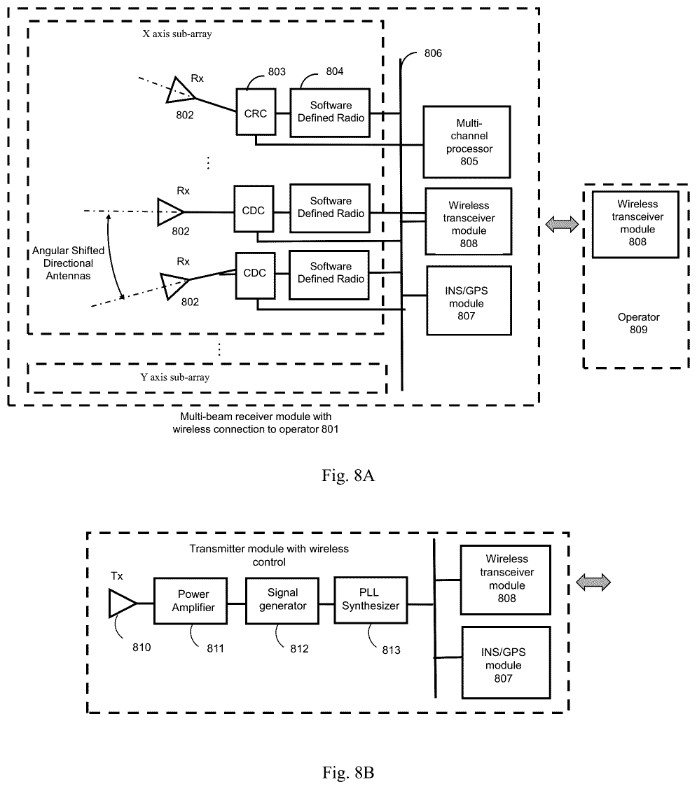

FIG. 8A shows multi-beam receiver antenna module 801 with wireless connection to operator. Module comprising multiple directional antennas 802 with overlap antenna patterns. Each directional antenna 802 coupled with Conditioning Receiving Circuit (CRC) 803 including voltage or current limiters, anti-aliasing circuits wherein each conditioning receiving chain and connected to software defined radio 804. All receiver antenna modules 801 connected to multi-channel signal processor 805 by digital interface 806 arranged as universal serial bus (USB) or microwave and/or fiber optic waveguides. Multi-channel signal processor 805 comprising INS/GPS module 807 for space orientation and wireless transceiver module 808 for communication with operator 809.

FIG. 8B show transmitter antenna module with wireless connection to operator. Module comprising antenna 810 coupled with transmitter circuit including power amplifier 811, signal generator 812 and phase lock loop 813. Transmitting circuit connected to INS/GPS module 814 and wireless transceiver module 815 by digital interface 816.

Possible embodiment of passive receiver antenna module with ultrawide band directional antenna presented in FIG. 9. Ultrawide band helical antenna 901 coupled with matching balun 902 and connected to conditioning circuit comprising limiter 903, low noise amplifier 904, mixer 905, Successive Detection Log Video Amplifiers (SDLVA) 906 and analog to digital converter (ADC) 907. Analog to digital converter 907 connected by digital interface 908 to signal processor. Successive Detection Log Video Amplifier (SDLVA) 906 is providing measuring of RF power at ultrawide band frequencies. They exhibit a flat frequency response and faster rise and fall times compared to other RF detectors. Mixer 905 also connected to phase lock loop 909 for up or down converting frequency of received signals.

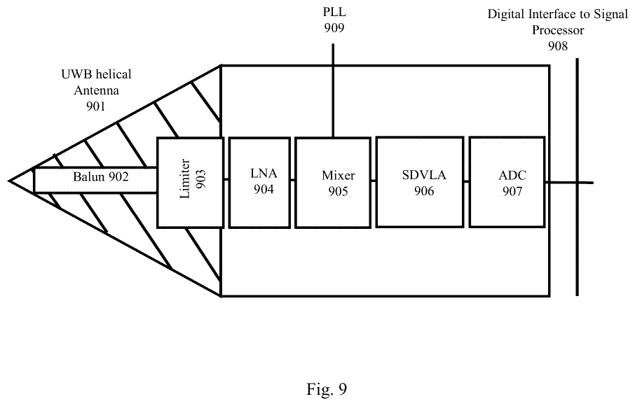

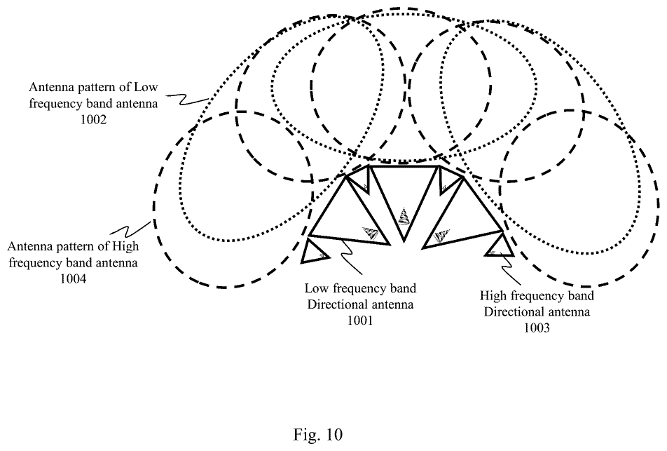

Proposed architecture of radar with multi-beam array of directional antennas allows to create multi-band antenna array module by arranging antennas of low frequency band and high frequency band in one integral module. Possible embodiment of multi-band directional antenna array with monopulse overlap antenna patterns is shown in FIG. 10. Low frequency band antennas 1001 with overlap antenna patterns 1002 can be combine with high frequency band antennas 1003 with overlap antenna patterns 1004.

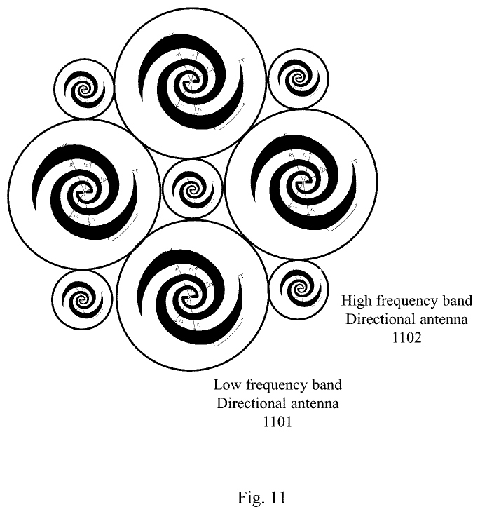

FIG. 11 shows sample of embodiment for two-band directional antenna array. Ultrawide band low frequency antennas 1101 and ultrawide band high frequency antennas 1102 are arranged in one antenna array module.

Diagram in FIG. 12 shows application of airborne drone for detection of hazard materials concealed on ground surface or underground.

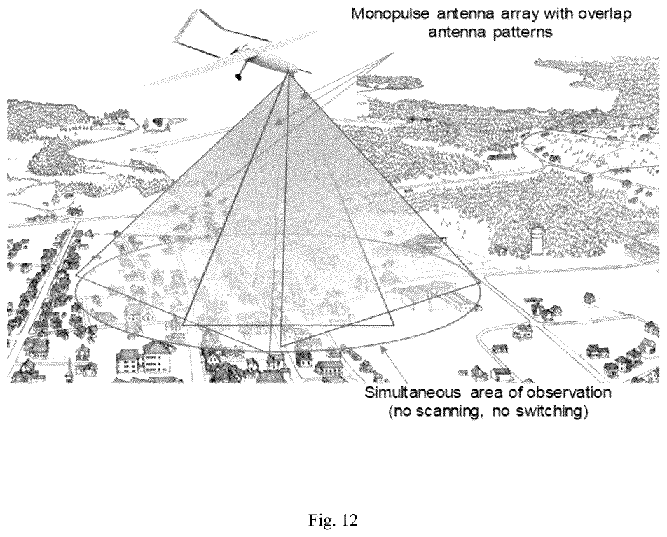

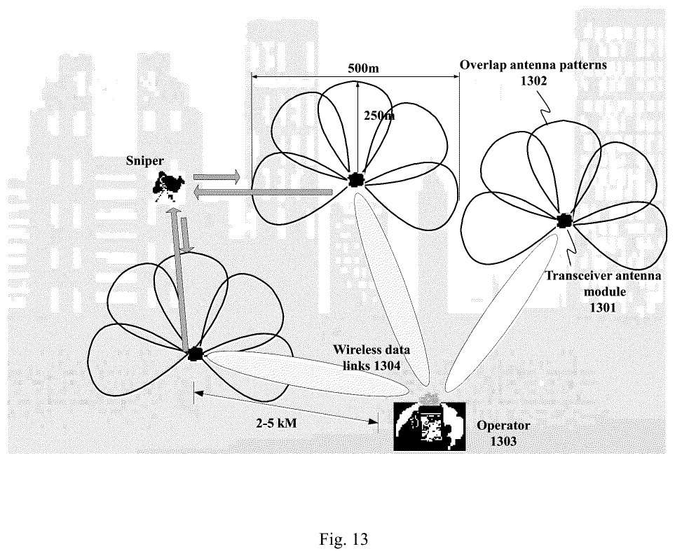

FIG. 13 shows multi-static sniper detection radar with multi-channel transceiver antenna modules and wireless connected operator. Multi-channel transceiver antenna modules 1301 with overlap antenna patterns 1302 are distributed in area of possible sniper position. Information about detected and identified sniper position transmitting to remote operator 1303 by wireless interface 1304.

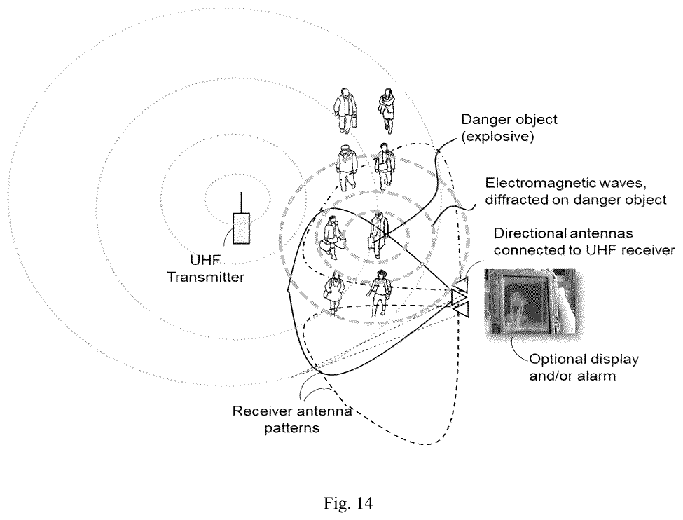

FIG. 14 shows sample of application of multi-channel multi-static radar for detection of concealed threats in airports. Ultra-high frequency transmitter 1401 positioning not far from possible passenger's stream. Operator with multi-channel passive receiver with directional antenna array 1402 can receive and automatic identify reflected signals remotely.

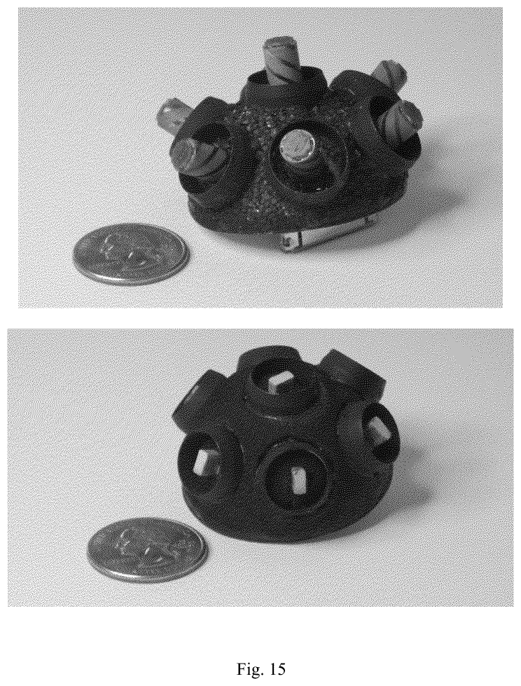

FIG. 15 shows samples of directional antenna modules for L1, L2 GPS frequency bands.

### REFERENCE NUMBERS

101—multi-beam antenna array
102—antenna patterns
103—object
201—multi-beam antenna array
202—antenna patterns
203—object
301—multi-beam transceiver antenna module
302—drone
303—transmitted RF signal
304—diffracted from sniper riffle RF signal
305—sniper with riffle
306—reflected from obstacles RF signals
307—obstacles
308—phase delay
309—time delay
310—Fast Fourier Transform from time to frequency domain
311—spectrum measurement result
312—library of spectrum signatures
401—frequency components proportional to size of object
402—frequency components proportional to dielectric constant of object material
403—time delay proportional to distance to object
501—increasing frequency components of object spectrum signature
502—decreasing frequency components of object spectrum signature
503—background spectrum components
601—object beam
602—reference beam (reflected from object)
603—reference beam (reflected from media)
604—Y axis transceiver
701—multi-beam transceiver antenna module
702—directional antennas
703—overlap antenna patterns
704—X-axis TAM with sub-array
705—Y-axis TAM with sub-array
706—covered space sector
707—transmitting chain
708—software defined radio
709—conditioning receiving chain
710—circulator
711—multi-channel signal processor
712—memory
713—monopulse processor
714—object identification means
715—synchronization means
801—multi-beam receiver antenna module
802—directional antennas
803—conditioning receiving chain
804—software defined radio
805—multi-channel signal processor
806—digital interface
807—INS/GPS module
808—wireless transceiver module
809—operator
810—antenna
811—power amplifier
812—signal generator
813—phase lock loop
814—INS/GPS module
815—wireless transceiver module
901—UWB helical antenna
902—balun
903—limiter
904—low noise amplifier
905—mixer
906—SDVLA
907—ADC
908—digital interface to signal processor
1001—low frequency band directional antenna
1002—antenna pattern of low frequency band directional antenna
1003—high frequency band directional antenna
1004—antenna pattern of high frequency band directional antenna
1101—low frequency band directional antenna
1102—high frequency band directional antenna
1301—multi-channel transceiver antenna module
1302—overlap antenna patterns
1303—operator
1304—wireless interface
1401—UHF transmitter
1402—operator

### Operation

Subarrays of neighboring directional antennas overlapping in one-axes, quadrature or in multi-axes directions. Such set of directional antennas with overlap antenna patterns provides high accuracy monopulse direction finding, and using of some reference antennas provides reliable objects recognition and adaptation for suppression of noises and influence of transferring media parameters. Each directional antenna coupled with separate transceiver chain and can simultaneously use full channels capacitance for separate transmitting and receiving signals and non-interrupting work.

Processing of received signals including sequence of operations, which can be providing in parallel. Real time digitizing of received signals simultaneous providing directly on each antenna with overlap antenna patterns by analog-to digital converters in software defined radios. Creation of real time three-dimensional interferograms (real time digital hologram) of one or multiple.

Transferring of interferogram to multi-beam signal processor providing by digital interface.

Monopulse processing of received signals providing by calculating object azimuth and range as ratio of amplitudes and/or phases in separate overlap antennas within one or a few axes sub-arrays.

Fourier Transform of digital interferograms from time domain to frequency domain.

Creation of spectrum signatures of objects.

Objects identification by compare with a priory recorded in library spectrum signatures.

Mapping objects size, form and positions.

Generation of object detection alarm signal.

The time of signals processing is significantly decreased because signals from all satellites and other communication nodes processing simultaneously, even compare to processing digitally by switching virtual beamforming receiving signals. For example, a scanning system typically processes only one beam at a time, holographic staring systems processes signals by switching virtual beams and monopulse system processing all beams simultaneously.

Also, holographic systems transmitting more powerful signals, since a scanning system contains a high gain antenna on both transmit and receive, and in monopulse system transmitting power spreading inside relative wide space sector. From another side, high gain antennas in monopulse systems provides better gain and sensitivity than holographic systems, where usually applied array of omnidirectional antennas, which need provide wide area of observation for each antenna array element, and virtual set of receiving signals antennas activated for very short time for one separate node. Practically monopulse system will provide same gain and sensitivity of antennas, as scanning system with similar directional antenna.

Monopulse method provides better beam pointing accuracy of 2-3 orders then scanning systems. Synchronizing of signals directly in antennas provide high accuracy amplitude and phase measurement. Non scanning antenna array is phase/frequency independent and can be multi-frequency, multi-function. All receiving chains using ratio of amplitudes, phases and relative frequency components shift of signals for multi-axis signal processing. Monopulse processor can consist of filters and processing means for separation clutter signals, background noise, compensate moving errors.

1. Multi-channel continuous wave radar for detection of concealed objects configured to transmit and receive horizontally, vertically or circular polarized waveforms comprising:
as minimum one transceiver antenna module with multiple directional antennas wherein antenna patterns overlap in one or more directions for creating monopulse subarrays continuously covering of entire area of observation or subdivided sector;
each directional antenna formed by subarray of antenna elements arranged in module volume, on module surface or combined;
said transceiver antenna module comprising as minimum one transmitting chain including phase lock loop, signal generator and controllable power amplifier coupled with directional antenna and connected to software defined radio;
said transceiver antenna module comprising multiple conditioning receiving chains including voltage or current limiters, anti-aliasing circuits wherein each conditioning receiving chain coupled with directional antenna and connected to software defined radio;
all transceiver antenna modules connected to multi-channel signal processor by digital interface arranged as universal serial bus (USB) or microwave and/or fiber optic waveguides;
multi-channel signal processor comprising memory, monopulse processor, objects identification means, and synchronization means, wherein memory arranged for storing executable instructions and for separate processing of amplitudes, phases, frequency components shift of signals in transmitting and receiving chains, monopulse processor arranged for simultaneous multi-axis processing of all signals in receiving chains for calculating objects azimuth and range as ratio of amplitudes and/or phase shift of signals, one-iteration adapting to decrease transferring media influence to receiving chain parameters by phase shift in subarray of neighboring directional antennas with overlap antenna patterns, objects identification means arranged to transform three-dimensional interferogram from time domain to frequency domain, creating objects spectrum signatures and identification of objects, synchronization means arranged for synchronizing transmitting, receiving chains and software defined radios with multi-channel signal processor time;
plurality of multi-beam antenna array modules can be distributed by some order on carrier/satellite, vehicle or distributed between swarm or constellation of carriers/satellites to cover entire sky or area of observation, better objects recognition and better jam, spoof protection of radar system.

2. Multi-channel continuous wave radar of claim 1, wherein transceiver antenna module arranged in concave, convex, cylindric full/hemi sphere shape consisting of plurality of antenna elements which forming directional antennas.

3. Multi-channel continuous wave radar of claim 1, wherein transmitting and receiving chains and multi-channel signal processor are arranged for simultaneous transmitting, receiving, and processing signals on a few different frequencies (multi-frequency signals) and comprising corresponding arranged directional antennas, anti-aliasing circuits and filtering means in each transmitter and receiving chain.

4. Multi-channel continuous wave radar of claim 1, wherein transmitting and receiving circuits and signal processor are arranged for simultaneous transmitting, receiving, and processing different modes and different waveforms signals, such as communication, navigation, control (multi-mode, multi-function signals) and comprising corresponding arranged directional antennas, anti-aliasing circuits and filtering means in each transmitter and receiving chain.

5. Multi-channel continuous wave radar of claim 1, wherein receiving circuits and multi-channel signal processor are arranged for simultaneous processing received signals for detection direction of arriving of jam and/or spoof signals and comprising corresponding arranged analog and digital filtering and/or switching protection means in each receiving chain and in each channel of signal processor.

6. Multi-channel continuous wave radar for detection of concealed objects configured to transmit and receive horizontally, vertically or circular polarized waveforms comprising:
as minimum one transmitter module comprising transmitting chain including phase lock loop signal generator, and controllable power amplifier coupled to as minimum one antenna continuously covering of entire area of observation or subdivided sector and connected by digital interface to wireless transceiver module and INS/GPS module;
multiple multi-beam receiver antenna modules comprising multiple directional antennas wherein antenna patterns overlap in one or more directions for creating monopulse subarrays continuously covering of entire area of observation or subdivided sector and comprising multiple conditioning receiving chains including voltage or current limiters, anti-aliasing circuits wherein each conditioning receiving chain coupled with separate directional antenna and software defined radio;
each directional antenna formed by subarray of antenna elements arranged in module volume, on module surface or combined;
all multi-beam receiver modules connected to multi-channel signal processor, wireless transceiver module and INS/GPS module by digital interface arranged as universal serial bus (USB) or microwave and/or fiber optic waveguides;
multi-channel signal processor comprising memory, monopulse processor, objects identification means and synchronization means, wherein memory arranged for storing executable instructions and for separate processing of amplitudes, phases, frequency components shift of signals in transmitting and receiving chains, monopulse processor arranged for simultaneous multi-axis processing of all signals in receiving chains for calculating objects azimuth and range as ratio of amplitudes and/or phase shift of signals, one-iteration adapting to decrease transferring media influence to receiving chain parameters by phase shift in subarray of neighboring directional antennas with overlap antenna patterns;
objects identification means arranged to transform three-dimensional interferogram from time domain to frequency domain, creating spectrum signatures and identification of objects, synchronization means arranged for synchronizing transmitting, receiving chains and software defined radios with multi-channel signal processor time;
transmitter module and plurality of multi-beam receiving modules can be distributed in area, where concealed object may be positioned or by some order on carrier/satellite, vehicle or distributed between swarm or constellation of carriers/satellites to cover entire sky or area of observation.
